(19) United States
(12) Patent Application Publication
(10) Pub. No.: US 2014/0047827 A1
(43) Pub. Date: Feb. 20, 2014

(54) AERATION IN LIQUID RESERVOIRS

(71) Applicants: Abdul Karim Maoued, Peoria, IL (US); Russell Ross Henderson, JR., Havana, IL (US); Randall Alan Harlow, Brimfield, IL (US); Mohamed Ibrahim Daoud, Dunlap, IL (US); Daniel Waite Uphoff, Congerville, IL (US)

(72) Inventors: Abdul Karim Maoued, Peoria, IL (US); Russell Ross Henderson, JR., Havana, IL (US); Randall Alan Harlow, Brimfield, IL (US); Mohamed Ibrahim Daoud, Dunlap, IL (US); Daniel Waite Uphoff, Congerville, IL (US)

(73) Assignee: CATERPILLAR INC., Peoria, IL (US)

(21) Appl. No.: 13/586,372

(22) Filed: Aug. 15, 2012

(51) Int. Cl. F15B 13/16; G01N 7/00

(52) U.S. Cl. 60/328; 73/19.05

(57) ABSTRACT

Generally, example systems and methods for measuring aeration level of a liquid may involve measuring the pressure at two points in the liquid reservoir. The aeration level of the liquid in the liquid reservoir may be calculated based on the pressure differential between the two points in the liquid reservoir. Optionally, the aeration level of the liquid may be compared to a threshold value of the liquid aeration level, and a machine action may be commanded if the aeration level exceeds the threshold value. Example machine actions may include warning the operator. In addition, data relating to the level of aeration of the liquid may be stored, along with other machine parameters, and the data correlated for analysis and machine diagnostics.

### TECHNICAL FIELD

The present disclosure relates generally to systems and methods for determining the aeration level of a liquid. More particularly, generally disclosed are systems and methods to measure the pressure differential in a liquid reservoir, which may then be used to determine the aeration level of the liquid in a liquid reservoir.

### BACKGROUND

The present disclosure contemplates that air may exist in a liquid in three different forms. One form is “free air,” which is the trapped air in a system but not totally in contact with the liquid; such as air pockets. Another form is “entrained air,” which exists in the form of bubbles in the body of the liquid, while the third form is “dissolved air” that is totally mixed with the liquid and exists at the molecular level. Free and entrained air usually gets into a system through different means, such as violent agitation, a leak in a connection or seal, or the release of dissolved air due to a pressure drop (e.g., at pump inlets).

It is well known that the presence of air (or other gases) in an actuation system, such as a hydraulic system, can cause considerable performance problems leading to malfunctioning of the system. First, air reduces the efficiency and consistency of a hydraulic liquid in transferring energy. Second, the presence of air in the working fluid of an actuation system can cause abnormal noise. With the hydraulic fluid contaminated by air, loud noise may be heard when the air compresses and decompresses as the fluid circulates through the system. Third, aeration can result in severe erosion of pump components when air bubbles present in hydraulic fluids collapse as they suddenly encounter high pressure at the discharge area of the pump. Fourth, air disrupts the expected heat transfer properties of the system. Other common problems caused by fluid aeration can include a lowering of the fluid's bulk modulus, an increase in the fluid's temperature, a loss of lubricity, excessive or premature oxidation of fluid handling components, wasted horsepower, and alteration of the system's natural frequency. Premature failure of system components leads to increased service cost and greater operational downtime for machines.

Knowing the amount of aeration in a hydraulic fluid can serve as a diagnostic tool in determining problems in the associated hydraulic system. It may also help prevent problems associated with aeration before they occur by ensuring that the amount of air in the fluid is constantly at an acceptable level.

There are several existing methods that are capable of measuring aeration in liquids. One method includes taking a sample of the liquid and then measuring the change in volume of the liquid as the air is allowed to escape from the sample. Other methods include the use of an infrared source focused on a liquid sample. U.S. Pat. No. 5,455,423 to Mount et. al. focuses an infrared source onto a venturi in a sample tube. The venturi is illuminated by the infrared source to detect and measure the amount of air bubbles in the liquid. Other methods to measure aeration known in the art include using X-rays to measure the density of the liquid. Still other methods examine the speed, temperature, and attitude of an engine relative to an axis (e.g., U.S. Pat. No. 6,758,187).

While these methods may detect the aeration of a liquid (specifically, the level of entrained air) to an adequate degree for some purposes, they have drawbacks. First, these methods require sampling the liquid from a working system to measure aeration. This often requires stopping the normal operation of the system or machine. Second, these methods may be costly. Third, the experimental setup of these methods may limit the ability to measure aeration levels at a specific location on a liquid system during normal operating conditions of a machine.

The present disclosure is directed to overcoming one or more of the problems set forth above.

### SUMMARY

Example methods for measuring aeration level of a liquid in a liquid reservoir are disclosed. In one exemplary embodiment, the method may include measuring the pressure at two points in the reservoir. The method may also include calculating the aeration level of the liquid in the liquid reservoir based on the two pressure measurements. The method may also include additional steps where the data collected by the controller may be stored for later use and/or analysis or where the controller sends a command that results in a warning being sent to the operator of the system or machine.

Some example systems for measuring the aeration level of a liquid in a liquid reservoir of a machine are also disclosed. Example systems may include two transducers that measure the pressure in the liquid reservoir. The example system may also include a controller, in communication with the two pressure transducers, configured to calculate the aeration level of the liquid in the reservoir based upon the pressure measurements.

Some example systems may include a machine including a liquid reservoir connected to an actuator. The machine may include two transducers that measure the pressure in the liquid reservoir. The two transducers may be in communication with a controller configured to calculate the aeration level of the liquid in the reservoir based upon the pressure measurements.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 is a schematic illustration of an example system that may be used to determine the aeration level of a liquid in a liquid reservoir;

FIG. 2 is a graph comparing the aeration level calculated using a density meter with the aeration level calculated using the pressure measurements in the liquid reservoir;

FIG. 3 is a schematic illustration of a configuration of an example machine that may determine the aeration level of a liquid in a liquid reservoir that is connected with an actuator;

FIG. 4 is a flowchart of an example method that may be used to determine the aeration level of a liquid in a liquid reservoir, and

FIG. 5 is a flowchart of an example method that may be used to command machine actions based upon the aeration level of a liquid in a liquid reservoir, all arranged in accordance with at least some embodiments of the present disclosure.

### DETAILED DESCRIPTION OF THE DRAWINGS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

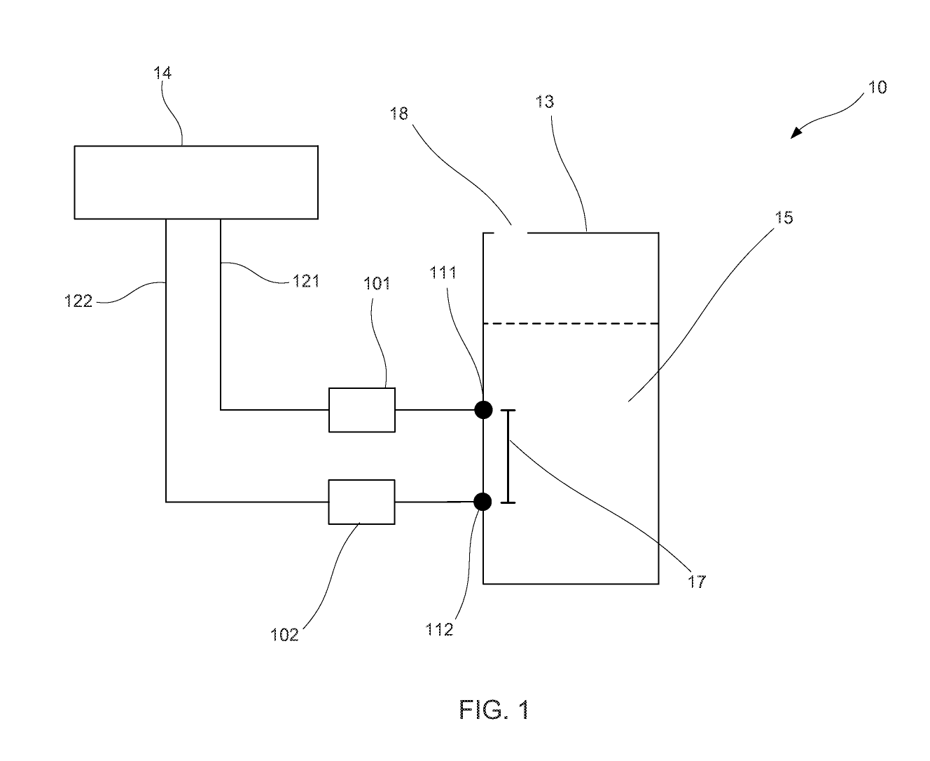

FIG. 1 depicts an exemplary system 10 for measuring the level of aeration of a liquid in a liquid reservoir. In the exemplary system 10, first transducer 101 and second transducer 102 may measure the pressure exerted on the wall of the liquid reservoir 13 at first location 111 and second location 112 respectively. Second location 112 may be located inferior to first location 111 on the wall of the liquid reservoir 13. The distance between the first location 111 and second location 112 may be a fixed length 17. First transducer 101 may measure the pressure exerted on the wall of the liquid reservoir 13 by the liquid 15 contained therein and then through the first communication means 121 may communicate the pressure measurement (P1) at first location 111 to the controller 14. Second transducer 102 may measure the pressure exerted on the wall of the liquid reservoir 13 by the liquid 15 contained therein and then through the second communication means 122 may communicate the pressure measurement (P2) at second location 112 to the controller 14. There may be a vent 18 in the liquid reservoir 13.

The controller 14 may use the first pressure measurement from the first location 111 (taken by the first transducer 101) and the second pressure measurement from the second location 112 (taken by the second transducer 102) and may calculate the measured liquid density (ρ_{measured}) of the liquid 15 located in the liquid reservoir 13. In order to calculate the measured liquid density (ρ_{measured}) the controller may first calculate the differential pressure (ΔP) between the second location 112 and the first location 111.

ΔP=P2−P1

Once the differential pressure (ΔP) is calculated the following equation may be used to calculate the measured liquid density (ρ_{measured}), where g is rate of gravitational acceleration and L is the fixed length 17 between first location 111 and second location 112:

ρ_{measured}=ΔP/(g*L)

Once the measured liquid density (ρ_{measured}) of the liquid 15 located in the liquid reservoir 13 is calculated, the controller 14 may use the following equation to calculate the aeration level (Ψ%) of the liquid 15 in the liquid reservoir 13, where ρ_{liquid} is the density of the pure liquid and ρₐᵢᵣ is the density of air:

Ψ%=(ρ_{liquid}−ρ_{measured})/(ρ_{liquid}−ρₐᵢᵣ)*100

Once the controller 14 has calculated the aeration level (Ψ%) of the liquid 15 in the liquid reservoir 13 it may compare the calculated aeration level (Ψ%) to a predetermined threshold value for aeration level (Ψ%) of the liquid 15. If the calculated aeration level (Ψ%) exceeds the threshold aeration level (Ψ%) then the controller 14 may command some machine action. The machine action may be a warning sent to the operator of a machine incorporating or connected to the controller 14. The machine action may also involve an adjustment of the aeration level (Ψ%) of the liquid 15 in the liquid reservoir 13. The controller 14 may store the calculated aeration level (Ψ%). The controller 14 may also compile additional diagnostic data related to other parameters of the liquid 15 in the liquid reservoir 13, such as the temperature of the air, temperature of the liquid 15 in the liquid reservoir 13, atmospheric pressure, or volume of the liquid 15 in the liquid reservoir 13. The controller 14 may store the additional diagnostic data related to other parameters of the liquid 15 in the liquid reservoir 13. The controller 14 may also correlate the other parameters with the aeration level of the liquid. The liquid 15 in the liquid reservoir 13 may be hydraulic fluid.

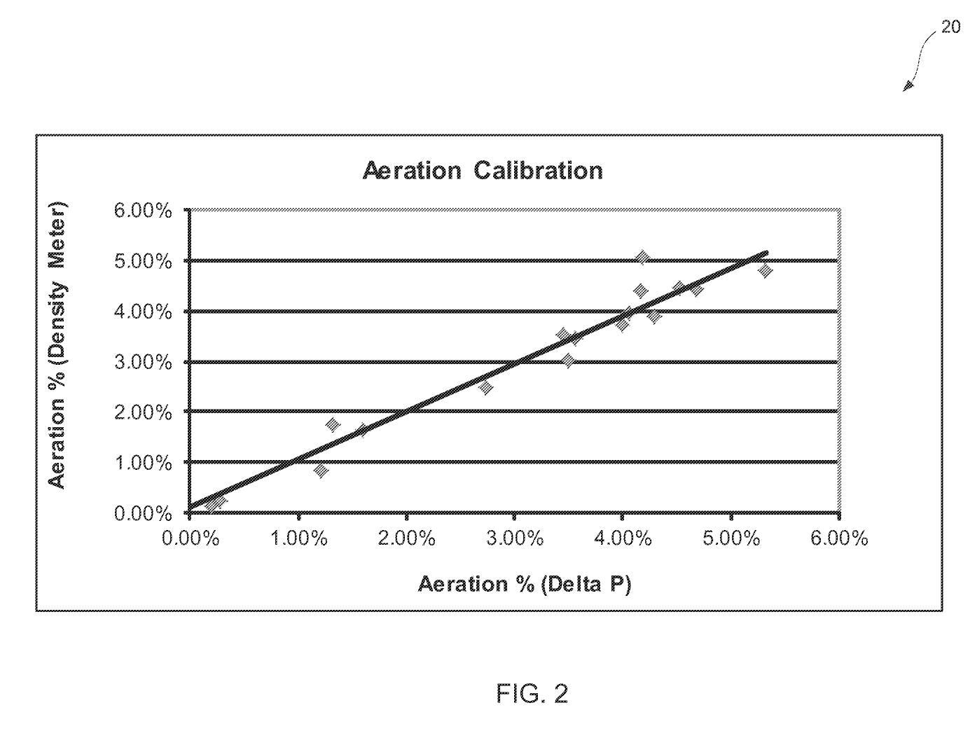

FIG. 2 is a calibration graph 20 comparing the level of aeration calculated using a density meter with the level of aeration calculated using the pressure measurements in the liquid reservoir. The controller 14 may use the calibration from the calibration graph 20 to provide more accurate aeration level (Ψ%) calculations. The y-axis on the calibration graph 20 represents aeration level measurements found by measuring the density of the liquid in the reservoir with a density meter, and then calculating the aeration level. The x-axis represents aeration level (Ψ%) calculations made using the method and system disclosed herein, where the pressure differential in the liquid reservoir is measured then used to calculate the aeration level (Ψ%).

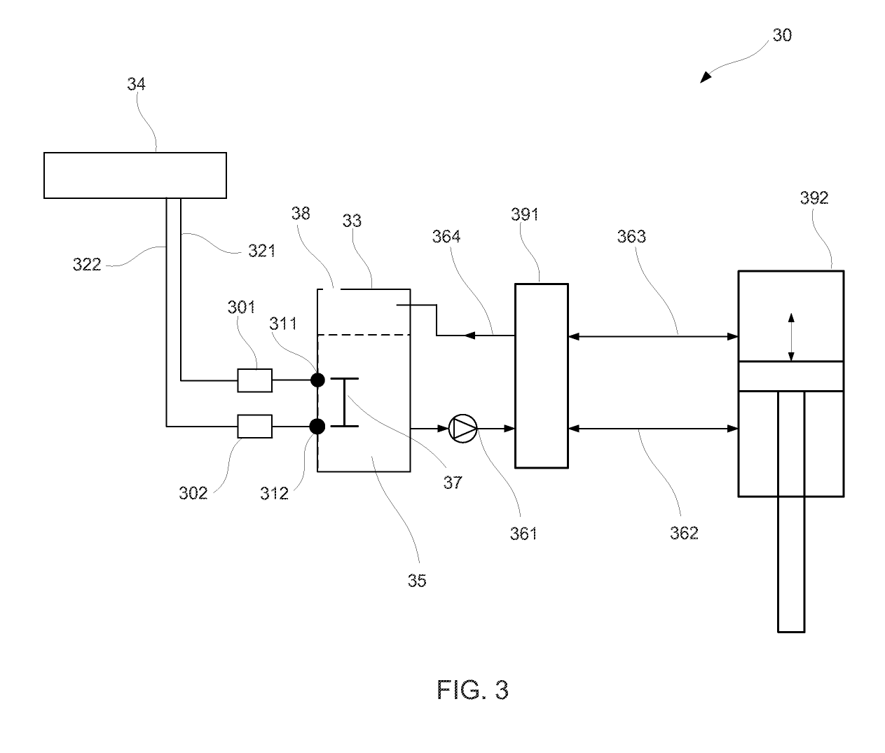

FIG. 3 depicts a schematic illustration of an example configuration of a exemplary machine 30 that may determine the aeration level (Ψ%) of a liquid 35 in a liquid reservoir 33 connected to an actuator 392. The components of the liquid reservoir are similar to the components described in FIG. 1. Again, first transducer 301 and second transducer 302 may measure the pressure exerted on the wall of the liquid reservoir 33 at first location 311 and second location 312 respectively. Second location 312 may be located inferior to first location 311 on the wall of the liquid reservoir 33. The distance between the first location 311 and second location 312 may be a fixed length 37. First transducer 301 may measure the pressure exerted on the wall of the liquid reservoir 33 by the liquid 35 contained therein and then through the first communication means 321 may communicate the pressure measurement (P1) at first location 311 to the controller 34. Second transducer 302 may measure the pressure exerted on the wall of the liquid reservoir 33 by the liquid 35 contained therein and then through the second communication means 322 may communicate the pressure measurement (P2) at second location 312 to the controller 34. There may be a vent 38 in the liquid reservoir 33.

The controller 34 may make the same calculations described above to calculate the aeration level (Ψ%) of the liquid 35 in the liquid reservoir 33. The controller 34 may also command machine action(s) if the calculated aeration level rises above a threshold aeration level, such as sending a warning to the operator of the machine or adjusting the aeration level of the liquid 35 in the liquid reservoir 33. The controller 34 may also compile and store diagnostic data on other parameters such as the air temperature, temperature of the liquid 35 in the liquid reservoir 33, atmospheric pressure, or volume of the liquid 35 in the liquid reservoir 33. The controller 34 may also correlate the other parameters with the aeration level.

Also present in some configurations of the exemplary machine 30 is a first transportation means 361 that may allow the liquid 35 to flow or be pumped from the liquid reservoir 33 to a control valve 391. In some exemplary machines the control valve 391 will affect the flow of the liquid 35 to an actuator 392. The liquid 35 may flow between the control valve 391 and the actuator 392 through a second transportation means 362 and third transportation means 363. The liquid may return to the liquid reservoir 33 from the control valve 391 through a fourth transportation means 364. In some exemplary machines, the aeration level (Ψ%) of the liquid 35 may be continuously monitored to ensure that the aeration level remains below a threshold level. The threshold level may be set at a level where aeration above that level may cause adverse effects in the performance or structure of the actuator 392 (e.g. noise, oxidation, loss in efficiency, unexpected heat transfer). In some exemplary machines 30, the liquid 35 in the liquid reservoir 33 being transferred to the actuator 392 may be hydraulic fluid.

In other embodiments a control valve may not be used and the actuator will be connected directly to the liquid reservoir. In these embodiments the liquid reservoir and the actuator may be in the same housing and the liquid will flow between the liquid reservoir and actuator through inlet and compensating ports. In these embodiments the liquid may then flow from the actuator to a hydraulic device. The hydraulic device may be a steering system, motor, hydraulic fan drive, hydrostatic transmission, brake system, or any other hydraulic system.

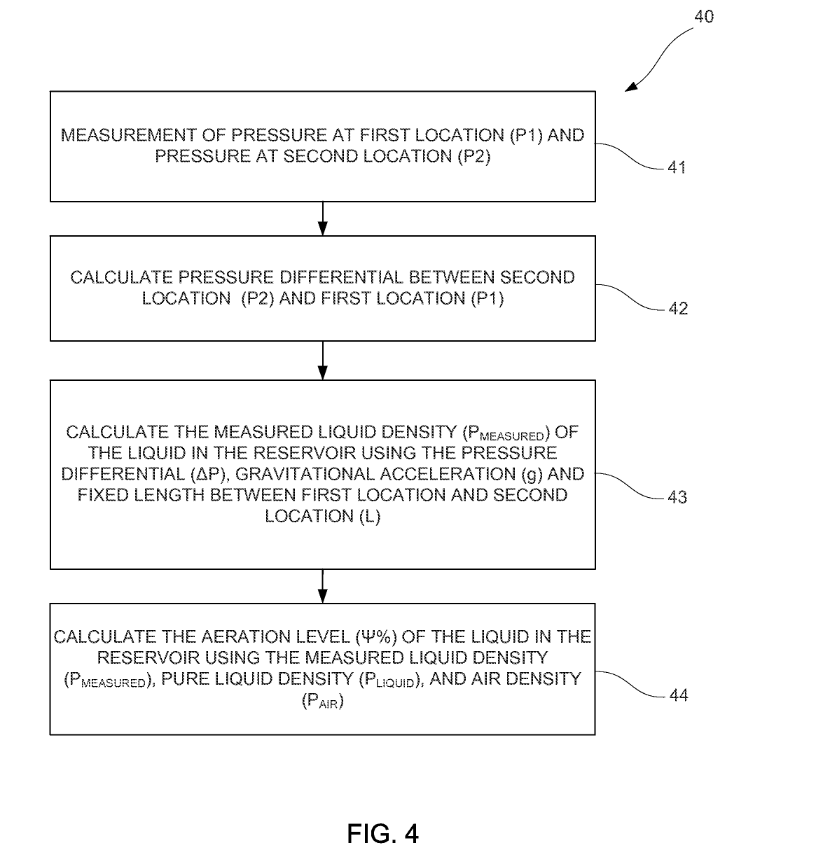

FIG. 4 is a flowchart of an exemplary method 40 to determine the aeration level of a liquid in a liquid reservoir. In step 41 the first pressure measurement (P1) may be made at the first location and the second pressure measurement (P2) may be made at the second location. In step 42 the pressure differential (ΔP) is calculated by taking the difference between the second pressure measurement (P2) and the first pressure measurement (P1). Next in step 43, the measured liquid density (ρ_{measured}) may be calculated using the pressure differential (ΔP) calculated in step 42, the rate of gravitational acceleration (g), and the fixed length (L) between the first location and the second location in the liquid reservoir. Next in step 44, the aeration level (Ψ%) may be calculated using the measured liquid density (ρ_{measured}) from step 43, the density of the pure liquid ρ_{liquid} and the density of air ρₐᵢᵣ.

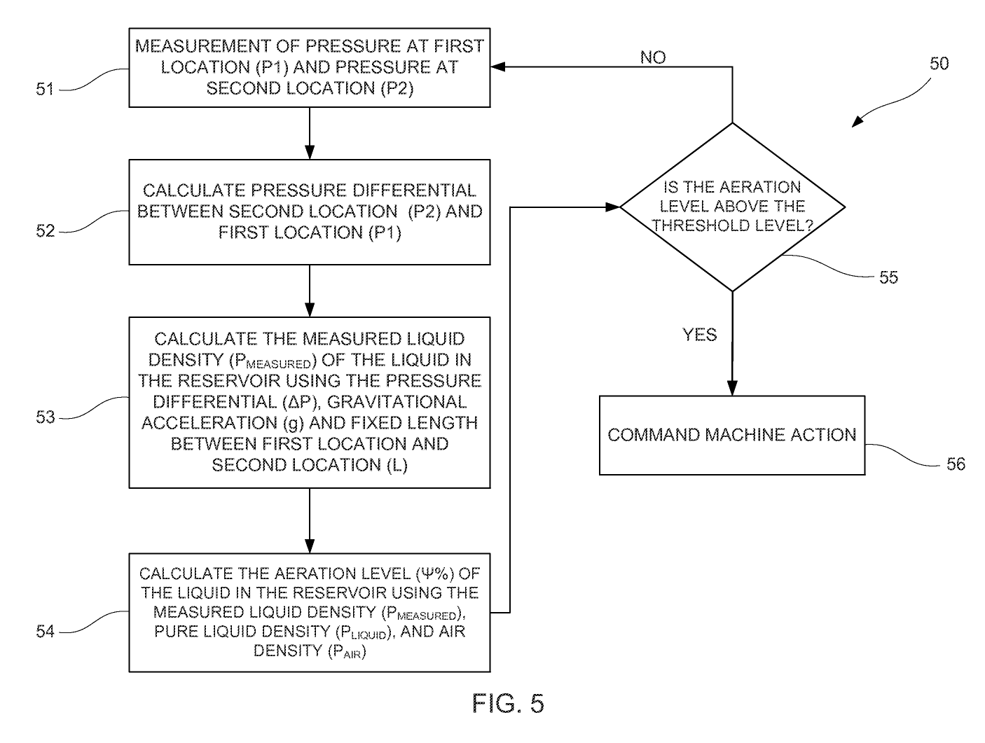

FIG. 5 is a flowchart an exemplary method 50 to command machine actions 56 based upon the aeration level of a liquid in a liquid reservoir. Step, 51, 52, 52, and 54 are similar to steps 41, 42, 43, and 44 described above. In step 55, the controller may determine whether the calculated aeration level (Ψ%) is above a threshold level. If the aeration level (Ψ%) is not above the threshold level then no machine action may be commanded. If the aeration level (Ψ%) is above the threshold level then a machine action may be commanded 56. The machine action may consist of a warning signal sent to the operator of the actuator connected to the liquid reservoir.

No matter what the aeration level (Ψ%), the controller may store the data compiled over time, including measured pressure at the first location (P1) and second location (P2), measured liquid density (ρ_{measured}), and the calculated aeration level (Ψ%). The exemplary methods 40 and 50 shows steps for continuously monitoring the aeration level in a liquid reservoir. Methods 40 and 50 may provide real-time measurements of aeration levels in the liquid reservoir. The controller may communicate the compiled data to a display screen that can be viewed by the operator.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### INDUSTRIAL APPLICABILITY

The present disclosure provides advantageous systems and methods for measuring the aeration level of a liquid in a liquid reservoir. Embodiments of the present disclosure may be used in a variety of different liquid reservoir systems of various configurations. Some embodiments may be for a static environment, wherein the liquid reservoir is stationary during while measuring the pressure differential between the first pressure transducer and the second pressure transducer and then calculating the aeration level of the liquid in the liquid reservoir. These embodiments may be configured for use as a stand-alone service tool. These embodiments may also be connected to a machine that uses the liquid in the liquid reservoir, but the liquid reservoir will remain stationary while the machine is in operation if it is connected to the machine while the machine is in operation or the connection to the machine will be removed before the machine is operated.

Some embodiments may be for a dynamic environment, wherein the liquid reservoir moves as the machine is in operation. Embodiments used in dynamic environments may still have the ability to accurately measure the pressure differential between the first transducer and the second transducer and therefore accurately calculate the aeration level of the liquid in liquid reservoir using the technique disclosed above. These embodiments may be embedded on a machine to measure aeration level during normal operation of the machine.

The techniques disclosed herein may be used in pump, control valves, cylinders, implement systems, steering systems, motors, hydraulic fan drives, hydrostatic transmissions, and brake systems.

The present disclosure may be advantageous over prior art systems in the ability to measure the aeration of a liquid with lower cost equipment, with a less complicated equipment setup. In addition, embodiments of the disclosure may allow an operator to access and measure the aeration level in a liquid reservoir which is less accessible to measurement via prior art techniques of measuring liquid aeration level. For example, the techniques disclosed herein may allow for equipment to be placed on only one side of a liquid reservoir, and do not require extracting and sampling the liquid for measurement.

Other embodiments, features, aspects, and principles of the disclosed examples will be apparent to those skilled in the art and may be implemented in various environments and systems.

What is claimed is:

1. A method for measuring the aeration of a liquid in a reservoir, comprising:
measuring a differential pressure in a liquid reservoir, and
calculating a level of aeration of the liquid in the liquid reservoir based on the differential pressure.

2. The method of claim 1, including the step of comparing the level of aeration of the liquid with a threshold value of liquid aeration.

3. The method of claim 2, including the step of commanding a machine action if the level of aeration of the liquid exceeds a threshold value of liquid aeration.

4. The method of claim 3, wherein the machine action includes warning an operator of a machine if the level of aeration of the liquid exceeds a threshold value of liquid aeration.

5. The method of claim 1, including the step of storing the level of aeration of the liquid calculated.

6. The method of claim 5, including the step of storing at least one other machine parameter.

7. The method of claim 6, including the step of correlating the at least one other machine parameter to the level of aeration of the liquid.

8. An aeration measurement system, comprising:
a reservoir configured to receive a liquid;
a first pressure transducer fixed to said reservoir at a first location and configured to detect a first pressure measurement at said first location;
a second pressure transducer fixed to said reservoir at a second location and configured to detect a second pressure measurement at said second location, where said second location is inferior to said first location by a distance;
a controller in communication with said first pressure transducer and said second pressure transducer, the controller being configured to determine the aeration of the liquid in said reservoir using said first pressure measurement, said second pressure measurement, and said distance.

9. The system of claim 8, wherein said controller compiles diagnostic data concerning the aeration level of the liquid in said reservoir.

10. The system of claim 9, wherein said controller commands a machine action if the aeration level of the liquid in said reservoir rises above a threshold level.

11. The system of claim 10, wherein the machine action includes warning an operator of a machine if the level of aeration of the liquid exceeds a threshold value of liquid aeration.

12. The system of claim 11, wherein the machine action further includes an adjustment of the aeration level of the liquid in the liquid reservoir.

13. The system of claim 12, wherein the liquid is hydraulic fluid.

14. A machine comprising:
a liquid reservoir containing a liquid;
a first pressure transducer,
a second pressure transducer;
a controller to calculate the level of aeration in the liquid based on data received from the first pressure transducer and the second pressure transducer.
an actuator that uses the liquid in the liquid reservoir
a pump configured to control the flow of the liquid from the liquid reservoir to the actuator

15. The machine of claim 14, including a data storage device for storing the level of aeration.

16. The machine of claim 15, wherein said controller commands a machine action if the aeration level of the liquid in said reservoir rises above a threshold level.

17. The machine of claim 16, wherein the machine action includes warning an operator of a machine if the level of aeration of the liquid exceeds a threshold value of liquid aeration.

18. The machine of claim 17, wherein the machine action further includes an adjustment of the aeration level of the liquid in the liquid reservoir.

19. The machine of claim 18, wherein the liquid reservoir contains hydraulic fluid.

20. The machine of claim 19, including a connection between the actuator and a hydraulic device.
